(19) United States
(12) Patent Application Publication
(10) Pub. No.: US 2002/0132059 A1
(43) Pub. Date: Sep. 19, 2002

(54) Light radiation cure coating composition and metal coil coating process employing same

(76) Inventors: John W. Maddox, Houston, TX (US); Brain L. Maddox, Houston, TX (US)

Correspondence Address: CONLEY ROSE & TAYON, P.C., P. O. BOX 3267, HOUSTON, TX, 77253-3267, US

(21) Appl. No.: 10/041,158

(22) Filed: Jan. 8, 2002

Related U.S. Application Data
(60) Provisional application No. 60/260,298, filed on Jan. 8, 2001.

(51) Int. Cl. B05D 3/00

(52) U.S. Cl. 427/487; 524/558

(57) ABSTRACT

This invention teaches that the use of high intensity light radiation equipment and unsaturated coating compositions for free radical curing will reduce energy consumption for coating the cleaned and prepared surfaces of coil sheet stock. Coating compositions as described reduce or eliminate solvents inherent in conventional heat cured conventional coil coatings and may eliminate air quality compliance equipment and the associated costs. Viscosity variations associated with solvent evaporation and the associated film faults are eliminated.

### CROSS-REFERENCE TO RELATED APPLICATIONS

This specification claims the benefit of provisional application serial No. 60/260,298 filed Jan. 8, 2001.

### STATEMENT REGARDING FEDERALLY SPONSORED

### RESEARCH OR DEVELOPMENT

Not applicable.

### FIELD OF THE INVENTION

The present invention relates generally to a process utilizing radiation curing equipment (high intensity light) and coating technology designed to advance the art for coating metal sheet coil in order to benefit the coil producer. Coil coaters coat metal coil composed of, but not limited to, galvanized metal, steel, aluminum and various forms and combinations of metals. These metals are selected for various end uses depending on their specific characteristics. In almost all cases, a key criteria is the ability to post form or bend the painted strip or sheet of coil. The coating must be flexible in order to allow the post forming or bending to occur without cracking and yet maintain adhesion and have hardness adequate to resist marking or film abrasion. Conventional, thermally cured coatings are very flexible and have good overall film properties consistent with the end use. Because the coil coatings may be post formed after painting using high speed processing equipment, metal bending can be very severe. Adhesion, abrasion resistance and flexibility are very necessary.

### BACKGROUND OF THE INVENTION

Coil coated metal products have a broad diversity and include, but are not limited to, the following products: container products including beer/beverage cans, ends and tabs, metal strapping and metal seals. Transportation applications include items such as automotive trim and travel trailers, building products such as ducts, residential siding and roofing, roof decking, building components and rain gutters are made from coil coat stock. Appliance parts include furnaces, baseboard hearing systems, control panels, washers and dryers. Furniture including blinds, fixtures and shelving are also made from coil coated metal.

Coatings used on building products, for example, include, but are not limited to the following types:

a. Polyester

b. Polyurethane

c. Acrylic

d. Vinyl

e. Alkyd

f. Silicon Polyester

g. Fluropolymer

The typical characteristics of a polyester for building products application are about as follows:

a. Cure range—(F.Peak Metal Temperature): 390-465 F. plus

b. Degree of cross-linking (Methal Ethyl Ketone) resistance 50-100 plus rubs

c. Flexibility/formability—NOT-3T bend

d. Film hardness—HB-2H

e. Dry film thickness—up to about 1.2 mills

f. Exterior weathering properties—good

The typical characteristics of a polyurethane for building products application are about as follows:

a. Cure range: 390-465 F.PMT

b. Degree of cross linking: 50-100 plus MEK rubs

c. Flexibility/formability: OT-2T

d. Film hardness: HB-2H

e. Dry film thickness: up to 1.2

f. Exterior weathering properties: good plus

The typical characteristics of an acrylic for building products application are about as follows:

a. Cure range: 420-500 F.PMT

b. Degree of cross linking: 50-100 plus MEK rubs

c. Flexibility/formability: 1T-3T

d. Hardness: HB-2H

e. Dry film thickness: up to 1.1 mills

f. Exterior weathering properties: good

The typical characteristics of a vinyl-solution or dispersion for building products application are about as follows:

a. Cure range: 300-420 F.PMT

b. Degree of cross linking: 0-100 plus MEK rubs

c. Flexibility/formability: OT-2T

d. Hardness: HB-2H

e. Dry film thickness: up to 4 mills

f. Exterior weathering properties: poor to good

g. Comments: cost high to very high because of the large amount of solvents needed

The typical characteristics of an Alkyd for building products application are about as follows:

a. Cure range: 380-450 F.PMT

b. Degree of cross linking: 50-100 MEK rubs

c. Flexibility/formability: 2T-4T

d. Dry film thickness: up to 1.2 mills

e. Exterior weathering properties: poor to good

The typical characteristics of a siliconized polyester for building products application are about as follows:

a. Cure range: 420-485 F.PMT

b. Degree of cross linking: 50-100 plus MEK rubs

c. Flexibility/formability: 2T-5T

d. Dry film thickness: up to 1 mill

e. Exterior weathering properties: very good

f. Comments: primer is generally required

The typical characteristics of a fluropolymer for building products application are about as follows:

a. Cure range: 420-480 F.PMT

b. Degree of cross linking: 50-100 plus MEK rubs

c. Flexibility/formability: OT-2T

d. Hardness: F-2H

e. Dry film thickness: up to about 1 mill

f. Exterior weathering properties: very good to outstanding

g. Comments: a primer is generally required

Primers are generally used to enhance adhesion and to extend corrosion protection. They also contain solvents, require oven cure to polymerize them, and typically have the same inherent problems, to varying degrees, as other solvent containing coatings.

The coil coating process is the continuous painting of a coiled metal substrate. The process typically consists of the following steps:

1. Coil Entry

The mill finish coil is placed into a decoiler for entry into the coating line after inspection. The head of the new coil is spliced into the tail of running coil. Splicing one to the other is accomplished by the utilization of an accumulation tower. The accumulation tower advances stopping the tail of the running coil at the splicing unit. Once the splice is made, the carriage is moved and the line returns to its normal running position.

2. Cleaning of the Coil

After the coil exits the entry accumulation tower, it enters the cleaning and rinse tank area. The cleaning tanks are designed to clean the metal. After cleaning the metal, it then passes through rinse tanks to assure that the cleaner residue is removed. If the metal is not cleaned properly, paint adhesion problems will occur.

3. Chemical Pretreatment

The chemical pretreatment or conversion coat step provides a protective layer to the substrate. This chemical treatment is designed to react with and modify the metal to produce a surface suitable for painting and to enhance the paint adhesion. This conversion coat also provides protection to the substrate from exterior corrosion. As the strip continues moving forward from the final rinse tank, it is dried and moves into the chemical coating section. Most coil coating lines apply the chemical treatment in one of two ways: the first method would be to pass the strip through a spray or dip tank and the second, and most environmentally safe method, is using a coil coater. After exiting the chemical coater, the strip moves directly into a drying oven which dries the chemical treatment and eliminates any moisture from the strip.

4. Application of Paint

The application of the paint to the chemically treated metal is accomplished by passing the strip through the paint roll coater. The paint roll coater consists of a series of rolls that support the applicator roll to apply the paint to the strip.

Proper coater roll setting and speeds must be monitored for accurate application of paint film. The correct paint film will vary, depending on the specification of each individual paint. Before any paint is used in the paint roll coater, it must be properly mixed to achieve the specified application viscosity. Periodic checks and viscosity adjustments must be made to allow for changes due to solvent evaporation, for example.

6. Curing the Paint

After the paint has been applied, the continuous strip then moves directly into the curing ovens. The curing ovens are generally natural gas fired, but may also be electric. Many variations of ovens exist, including high velocity moving air for example. The oven temperatures must be set at a temperature level to achieve a peak metal temperature sufficient to cause the coating to polymerize. The basic requirements needed to cure or polymerize the coating are metal temperature and time. Oven temperature adjustments are made, taking into consideration line speed, coating composition, film thickness and metal thickness. When the conditions are all correct, the result will be a properly cured coating.

It should be noted that steps number 4 and 5 describe the application of a single coat finish. The application of a primer coat before the finish coat would describe a tandem or two-coat coating line.

6. Cooling the Strip

The painted strip moves directly from the curing oven or ovens to the water quench or cooling section of the line. The cooling section of the continuous coating line is typically a tank with a series of upper and lower water sprays or modification thereof. The purpose of the water sprays is to cool the cured strip so recoiling of the continuous strip can be achieved.

7. Recoiling the Strip

The exit or recoiling end of the continuous coating line is typically made up of the exit accumulator tower, a shear unit, two coil recoilers, and a method of coil tracking. As the coated strip exits the cooling section, it moves directly into the exit accumulation tower and to one of two recoiling units. When a splice moves toward the recoiler, indicating the end of one coil and the beginning of a new coil, a cut must be made to start the new coil on the second recoiler. This is accomplished by utilizing the accumulator to provide enough strip to avoid the shutting down of the line to make the cut and start the new coil on a recoiler.

Once the new coil is started, the completed coil on the opposite recoiler is removed. A sample of the completed coil is taken to the quality control lab for testing and then sent to packaging. The following typical Quality Control procedures meet or exceed the coil coating industry.

Typical Quality Control Procedures

Paint dry film thickness generally is about 0.700-0.900 whenever a “full coat” is specified. Primers, tie or wash coats 0.150-0.300 film is typical. Film thickness may vary depending on the type of coating selected.

Gloss standards for high gloss will be a minimum of 80 degrees; medium gloss 30 degrees plus or minus 5 degrees; and low gloss 10 degrees plus or minus 2 degrees.

The paint film is typically expected to have a pencil hardness of F-2H pencil when tested by the approved method using Eagle Turquoise pencils. Some coil companies have test variations.

Cure or polymerization may be at 100 plus double rubs and will vary to meet specific requirements for a given coated product. Metallics may be plus or minus 50, depending. Rubs typically can be in a puddle of MEK using cheese cloth over the index finger. After rubs are complete, scratch a line with the fingernail across rubbed area, and rub over scratch with thumb to see if any flaking occurs. The techniques may vary from coil company to company.

Reverse impact must be tested at a minimum of one and one-half times metal thickness. The deformed area should show no pick off and no paint cracking when Scotch 600 tape is applied to the deformed area and sharply removed.

T-bend will be made on a 180 degree bend with a radius of combined metal thickness. Standard T-bend requirements are as follows:

| | |
|---|---|
| Two times metal thickness = | 0T-bend |
| Three times metal thickness = | 1T-bend |
| Four times metal thickness = | 2T-bend |
| Five times metal thickness = | 3T-bend |
| Six times metal thickness = | 4T-bend |
| Seven times metal thickness = | 5T-bend |

Apply No. 600 Scotch tape to the entire bend area and remove sharply. There must be no pick off (paint adhering to the tape) on the tape to accomplish the desired T-bend.

Cross-hatch adhesion test consists of using a sharp knife mark 10 parallel cuts at a spacing of 1/16″ and 10 cuts at a 90 degree crossing the original cuts. No paint pick off should show when No. 600 Scotch tape is applied to the cut area and sharply removed.

Colors must match approved standards at plus or minus 0.5 at all Delta readings when tested on a Hunter Color Difference Meter. Tolerance for deep colors and metallics will be established.

Surface appearance must be commercially smooth and free from all metal and paint imperfections.

All of the foregoing aspects of coil coating will be familiar to those or ordinary skill in the coil coating art.

Although the coil coating process is already fairly efficient compared to many other coating techniques, the industry is continuously striving to improve efficiency, reduce energy consumption, reduce solvent emissions and/or eliminate volatile organic compounds (VOCs) (solvents) by employment of emission abatement techniques and increase production line speeds. Nonetheless, currently employed solvent-based techniques still produce undesirably high levels of solvent vapor and require relatively large amounts of energy. Hence, it is desired to provide a coil coating system that does not generate solvent vapor, is energy efficient, and does not require the use of undue amounts of energy. While it has been known that light-cured coatings provide many of the desired advantages, it has not heretofore been known how to provide a light-curable coating that, when applied and cured, meets the functional requirements for commercial coating applications.

### BRIEF SUMMARY OF SOME OF THE PREFERRED EMBODIMENTS

The present invention provides a method and composition for coating coils. The present method and composition avoid many of the problems associated with prior art coating processes. According to the present invention, light radiation is used to cure (polymerize) a polymeric coating. The flat substrate accommodates the roll coater process and is the preferred form for light radiation curing. Finally, the nature of the very rapid cure has distinct advantages in space and controllability. The radiation curing equipment produces light emissions in the ultraviolet and near visible spectrum. The benefits of this technology include, but are not limited to the elimination of solvent, reduced fire hazard, reduction or elimination of film faults normally associated with solvent type coatings, improved coating viscosity control and reduced energy use.

Coil coating process according to the present invention and coating compositions cured by free radical polymerization process, according to the preferred embodiments, are especially useful for coating the surface of coil sheet stock comprised of metals such as cold rolled steel, galvanized steel, aluminum, galvalume and hot dipped galvanized metal. Particularly, such metal substrate coating compositions have unsaturated double bond groups which are polymerized by free radical mechanism upon application of high intensity light radiation from a suitable light source such as, for example, a Fusion U.V. Curing System model F-600. The present compositions are typically in liquid form with about zero volatiles as measured at 77° F. Additionally, the present coatings can be clear, semi-transparent or opaque.

The free radical coating polymerization is induced by the high energy light radiation emanating from a bulb and reflector, directed to the coating. The light radiation wave length or nanometers may vary, depending on the bulb or bulbs, and, as a result, penetrate to a greater or lesser degree, depending on the power output and the coating film thickness. A coating having a high degree of opacity as compared to a transparent coating will require more energy for polymerization at equal film thickness. Compositions will vary, as will the requirements for energy, nanometer radiation and exposure time. Compositions having acceptable film performance for coil coating such as adhesion, flexibility, durability, chemical resistance, weatherability and hardness are described. Various coating compositions of the type described in this specification are used in conjunction with a high intensity light source unit or units to polymerize the film.

The disclosed devices and methods comprise a combination of features and advantages which enable it to overcome the deficiencies of the prior art devices. Specifically, the present coatings can be light cured and, once cured, meet or exceed functional requirements for commercial coating applications. The various characteristics described above, as well as other features, will be readily apparent to those skilled in the art upon reading the following detailed description, and by referring to the accompanying drawings.

### DETAILED DESCRIPTION OF THE PREFERRED EMBODIMENTS

The preferred embodiments of the present invention comprise an improved process for coating of metal coil sheet stock utilizing coating compositions cured by free radical polymerization. The metal coil sheet stock that can be coated using the present invention include such metals as cold rolled steel, aluminum, electrogalvanized steel, hot dipped galvanized steel, and Galvalume, for example. The coating compositions are preferably polymerized by a free radical mechanism induced by light radiation from a high intensity radiation equipment source such as Fusion U.V. Curing systems model F-600 or similar light generating unit. The free radical polymerization involves three stages: (1) population of the chemically reactive excited state, which requires light absorption and may also involve intersystem crossing and photosensitization; (2) formation of the initiator radicals by photocleavage of the reactive excited state or by H-abstraction from an H-donor; and (3) initiation of the polymerization by interaction of initiator radicals with monomers and oligomers.

It will be understood that different coating compositions have different energy requirements necessary for polymerization in order to obtain the film properties that the composition was formulated to achieve. The coatings are both utilitarian and decorative, and may include dyes or pigments as a component or components of the specific composition. Pigments typically interfere with light absorption, increasing the time for polymerization and requiring different energy requirements. It should also be understood that typical cure rates can only be determined after the issues of substrate, composition of the coating, energy intensity, film thickness, radiation special output and coating process are considered.

The application of a light-cured coating to a coil according to the present invention preferably involves the following process steps:

(1) coil entry

(2) cleaning and pretreating and drying of the coil

(3) coating of the coil

(4) curing of the coating by light radiation

(5) quench, if required

(6) recoil

Compositions having commercially acceptable film performance for metal coil sheet stock coating such as adhesion, flexibility, durability, chemical resistance and hardness are described. It should also be borne in mind that though the present invention is described in detail herein, particularly as it relates to coatings for coil sheet stock, the coating compositions and process of this invention have effective application for coating a wide variety of metal surfaces; thus, the present invention is not intended to be limited to coil sheet stock. Various coating compositions of the type described in this specification are used in conjunction with light radiation curing equipment unit or units to polymerize the film. Those skilled in the art will appreciate that modifications may be made to the invention without departing from the spirit and scope thereof. Therefore, it is not intended that the scope of the invention be limited to the specific compositions described. Both clear and pigmented coatings of various gloss levels are described in this invention.

The coating formulation components of the present invention include monomers and oligomers having the capability of being cured by light radiation extending from the low ultraviolet to the near visible range and may optionally include: cure additives, adhesion promoters, wetting agents, flow additives, color pigments or dyes, gloss reducing aids and dispersing agents. Examples of a wetting agent is OSI product L-7500, and an example of an adhesion promoter is UCB product 169.

The present coating compositions may be applied on either one or two sides of the coil sheet stock separately or collectively. A primer coating may be applied and cured followed by a topcoat application and cured on the coil currently being processed.

Examples of the specific embodiments illustrated and described are as follows:

### EXAMPLE 1

A coating composition as following with an application on cleaned and pretreated coil sheet stock.

1. Off-White Medium Gloss Coating

A coating composition for producing an off-white medium gloss coating in accordance with a preferred embodiment includes a difunctional unsaturated modified oligomer having a molecular weight from about 500 to about 10,000, preferably from about 500 to about 8000, and even more preferably from about 500 to about 6000. The oligomer preferably comprises from about 15 percent to about 70 percent by weight of the total composition. The modification of the difunctional unsaturated oligomer is completed with either a Urethane or a Polybutadiene backbone. The composition further includes from about 20 percent to about 60 percent by weight of a monofunctional unsaturated acrylic monomer having a molecular weight from about 125 to about 475. The composition further includes from about 5 percent to about 30 percent of a difunctional unsaturated monomer having a molecular weight from about 150 to about 400.

The composition further includes a photo-initiator or photo-initiators such as the BAPO (bis acyl phosphine oxide) class of initiators and 1-hydroxycyclohexyl phenyl ketone, for example. The combination of photo-initiators may form from about two to about 15 percent by weight of the total composition and more preferably from about four to about 10 percent by weight.

The composition preferably further includes from about 8 percent to 25 percent by weight titanium dioxide pigment, from about 0.5 percent to about 6 percent by weight yellow oxide pigment, and up to about 12 percent by weight zinc stearate or other pigments for reducing gloss. Additives for dispersion, flow and leveling, adhesion and cure may optionally be added up to a maximum of about 12 percent. The pigments are preferably milled or dispersed to yield a maximum particle size of 20 microns and more preferably a maximum of 10 microns, and to minimize or eliminate problems such as hard settling.

The coating was applied to clean, pretreated panels derived from galvanized and aluminum coil sheet stock. The panels were coated at temperatures ranging from about 70° to about 125° F. The application method was by a Bird applicator bar and the coating temperature ranged from about 70° F. to about 150° F. The typical film thickness was from about 0.6 to about 0.9 mill. The coating was light-cured using A Fusion U.V. Curing Systems, Inc. unit model F-300 with conveyor. The F-300 incorporated a “V” type bulb and the light unit was adjusted to be in focus.

The panels were passed under the light at various conveyor speeds having exposure times from about 5 seconds to about 10 seconds. The “V” bulb was replaced with an “H” bulb and the panels were again passed under the light, repeating the relative conveyor speeds and having exposure times from about 5 seconds to about 10 seconds. The panels were tested after 15 minutes with the following results:

| | |
|---|---|
| Bend | 2T to 3T meeting requirements |
| Hardness | Pencil hardness from about F to HB providing |
| | acceptable results |
| Adhesion | No pick off on the cross hatch area using the |
| | approved method |
| Reverse Impact | Pass 2 times metal thickness giving acceptable results |
| M.E.K. | Pass specific requirements as specified |

The same coating and procedures as above were made, with the exception that the light source was moved 1 inch out of focus. The results were predictable and the panels cured at shorter exposure times did not perform as well as the counterpart panels having the light source in focus, as a result of reduced light energy.

A coating composition is provided for application on galvanized prepared coil sheet stock as follows:

2. Clear Tie Coat

A coating composition for producing a clear tie coat in accordance with a preferred embodiment includes from about 25 to about 65 weight percent of a difunctional unsaturated oligomer having a molecular weight from about 500 to about 6000, from about 5 to about 65 weight percent of a monofunctional unsaturated monomer having a molecular weight from about 150 to about 325, and from about 1 to about 25 weight percent of a monofunctional unsaturated monomer having a molecular weight from about 100 to 300.

The composition further preferably includes from about 5 to about 20 weight percent corrosion inhibiting pigments and a photo-initiator or combination of photo-initiators being primarily reactive to light energy in the spectral range from the low ultraviolet and/or visible area. Typically, this range is from about 100 nanometers to about 500 nanometers. The photo-initiator or photo initiators may consist of, for example, 2-hydroxy-2-methyl-1-phenyl-propan-1-one (HMPP) or 1-hydroxycyclohexyl phenyl ketone (HCPK) or a combination of the two comprising weight percentages from about two to about twelve weight percent, and preferably from about two to about eight weight percent of the total composition.

The above coating when applied to cleaned and prepared galvanized coil sheet stock panels by means of a Bird wet film applicator generated an average film thickness of about 0.1 mill. The panels coated with the above composition were exposed to high energy light generated from a Fusion U.V. Systems, Inc. model F-600. This unit was fitted with a Fusion U.V. Systems, Inc. type “H” bulb having a typical power output of 600 Watts per inch. The bulb having a typical spectral output from about 200 nanometers through about 600 nanometers with the major output being from about 200 nanometers through about 320 nanometers.

The Fusion U.V. Systems, Inc. F-600 unit was equipped with a conveyor and the coated panels were transported under the light unit, which was adjusted to be in focus. Exposure to the light radiation was a maximum of 6 seconds. The panels were tested after 15 minutes with the following results being typical:

| | |
|---|---|
| Bend | 0T to 1T |
| Cure | No tack |
| Adhesion | Pass in accordance with the prescribed specifications |
| Impact | Pass in accordance with the prescribed specifications |

The cured film performance of the described composition meets prescribed composition meets prescribed requirements for bend, impact, adhesion, hardness, cure and solvent resistance.

A coating composition is provided for application on both aluminum and galvanized prepared coil sheet stock as follows:

3. Gloss Clear Coating

A coating composition for producing a gloss clear coating in accordance with a preferred embodiment includes from about 10 to about 60 weight percent of a difunctional unsaturated oligomer having a molecular weight from about 500 to about 10,000, more preferably from about 500 to about 8,000, and still more preferably from about 500 to about 6000, from about 12 to about 50 weight percent of an unsaturated oligomer having a molecular weight from about 500 to about 8000, more preferably from about 500 to about 6000, and still more preferably from about 500 to about 5000, and from about 5 to about 50 weight percent of a monofunctional unsaturated monomer having a molecular weight from about 130 to about 420.

The composition preferably further includes from about two percent by weight to about 10 percent by weight of a photo initiator or initiators such as, for example, 1-hydroxycyclohexyl phenyl ketone (HCPK) or 2-hydroxy-2-methyl-1-phenyl-propan-1-one (HMPP), these being primarily reactive to light energy in the spectral range from about 100 nm to about 400 mn. Additives are optionally included for enhancing adhesion, flow, leveling and other film properties, and comprise a combined weight percentage not more than seven percent of the total composition. An example of an adhesion promoter is UCB product 160; an example of a wetting agent is OSI L-7500; an example of a flow or leveling agent is Tego Chemie-Tego Glide 440.

The gloss clear coating, when applied to cleaned and pretreated galvanized coil sheet stock panels by means of a 0.0015 Bird wet film applicator, generated an average film thickness of about 0.5 mill. The panels coated with the above formulation were exposed to light energy generated from typically rated at 300 watts per inch. A Fusion U.V. Systems, Inc. bulb designated as type “H” was installed irradiation was less than 5 seconds. The panels with the cured film were allowed to “age” for 15 minutes and then bent to a 1T bend. A 1T bend is three times metal thickness.

Scotch No. 600 tape was applied to bend radius and removed. The tape showed no film removal. The bent film was then checked, using a solution of copper sulfate to further check for any evidence of coating fracture or removal. No evidence of film removal or fractures was observed. The ASTM cross hatch method indicated adhesion results to be 100%. Direct impact testing exceeded 120 inch lbs. The deformed area showed no pick off and no coating removal when No. 600 tape was applied to the deformed area and removed. The paint film pencil hardness was about an “H” using an Eagle Turquoise pencil. MEK (Methyl Ethyl Ketone) rubs exceeded 100 total and were made using wetted cheese cloth and applied with the index finger as is typically done in the coil coating industry.

A panel of cleaned and pretreated aluminum coil sheet stock was coated by wire rod method and the coating cured using the same light generating equipment with a duplicate procedure. The coating was about 0.4 mill thick on the average, and the testing of the cured film was accomplished 15 minutes after cure. The result of the cross hatch adhesion test was 100% adhesion. Impact testing was over 120″ lbs. direct and over 20″ lbs. reverse with no pick off using 3M No. 600 tape. Pencil hardness was from F to H. M.E.K. rubs exceeded 100.

The film properties of the gloss coat as described meet the typical film properties required for a coil coating as outlined in the Quality Control Procedure described above.

A coating composition is provided for application on both aluminum and galvanized prepared coil sheet stock as follows:

4. Semi-transparent Color Coating

A coating composition for producing a semi-transparent color coating in accordance with a preferred embodiment includes from about 20 to about 70 weight percent of a modified difunctional unsaturated oligomer having a molecular weight from about 500 to 10,000, preferably from about 500 to about 8000, and still more preferably from about 500 to about 6000, from about 30 to about 55 weight percent of a difunctional unsaturated monomer having a molecular weight from about 175 to about 475, and from about 3 to about 25 weight percent of a monofunctional unsaturated monomer having a molecular weight of from 130 to 320.

The composition may optionally include additives to enhance coating properties, including but not limited to: leveling, flow, dispersion, cure, adhesion or other film properties. The additives preferably do not exceed 14 percent by weight of the total composition. The composition preferably further includes thallo green pigment and thallo blue pigment in a 1:1 weight ratio combination, preferably not to exceed 20 percent by weight of the total. The pigments, in combination, are preferably milled to yield a micron size less than 20.

The composition further includes one or more photo initiators such as, for example, 2-hydroxy-2-methyl-1phenyl-propan-1-one or 1-hydroxycyclohexyl phenyl ketone and 2,2-dimethoxy-2-phenyl acetophenone or, for example BAPO (bis acyl phosphine oxide) class. The photoinitiators are preferably primarily reactive from about 150 nm to about 450 nm and comprise from about three percent by weight to about ten percent by weight of the total. In one preferred embodiment, two photoinitiators, having primary reactivity from about 100 nm to about 500 nm can be added in combined total weight percentage from about 5 to about 7. More specifically, one photoinitiator can have a primary reactivity in the range of from about 100 nm to about 375 mn and the other can have a primary reactivity between about 250 nm and about 500 nm.

The semi-transparent coating was applied to cleaned and pretreated galvanized panels from coil stock at a film thickness of about 0.3 mill. The coating was partially transparent at this film thickness. The application method was completed using a 0.0015 Bird application bar.

The panel was cured using a Fusion U.V. Systems, Inc. light generator model F-300 with a Fusion U.V. Systems, Inc. type “D” bulb described. The panel was exposed to the light by means of a conveyor transporting the panel under the light. Total exposure time was less than four seconds. The coating was at a distance from the light so as to be considered in focus. The film was tested 15 minutes after cure with the following results:

| | |
|---|---|
| Adhesion | 100% |
| Hardness | F to H |
| Bend | 3T |
| Gloss | Over 80% on a 60 meter |
| M.E.K. | Passed specification |

A coating composition is provided for application on both aluminum and cold rolled steel cleaned and pretreated coil sheet stock as follows:

5. Reduced Gloss Primer Coating

A coating composition for producing a reduced gloss primer coating in accordance with a preferred embodiment includes from about 16 to about 65 percent by weight of a difunctional unsaturated oligomer having a molecular weight from 500 to 10,000, and more preferably from about 500 to about 6000, from about 9 to about 40 percent by weight of a monofunctional unsaturated oligomer having a molecular weight from about 500 to about 8000, preferably from about 500 to about 7000, and still more preferably from about 500 to about 6000. The coating composition also comprises from about 5 percent to about 40 percent of a monomer having a molecular weight from about 130 to 320.

The composition further includes a photo-initiator or photo-initiators having their primary reactivity from about 150 nm to about 450 mn and being, for example, BAPO (Bis Acyl Phosphine Oxide) and 1-hydroxycyclohexyl phenyl ketone (HCPK) and comprising from about three percent by weight to about nine percent by weight.

Strontium, zinc, phospho-silicate or other similar type pigments or combinations of pigments can be added, up to about a maximum level of 28 percent by weight. Optional additives, including but not limited to, for example 169 from UCB for adhesion and L-7500 from OXI for wetting, can be added. The additives preferably form not more than eight percent by weight of the total.

The above coating composition was applied to clean, pretreated panels derived from both steel and aluminum coil sheet stock. The panels were coated at metal temperatures of about 110 F. Application was by a 0.0015 Bird applicator with the panels on a vacuum plate. Typical film thickness was about 0.2 to 0.4 mill. Cure was with two Fusion U.V. Curing Systems F-600 units wit conveyor. Total light exposure was about four seconds and the bulbs were a “D” followed by an “H” adjusted to be in focus. The panels were tested about 20 minutes after cure and found to have the following characteristics:

| | |
|---|---|
| Adhesion | 100% using the prescribed method |
| Impact | Over 100 inch lbs. direct and 10 inch lbs. Reverse |
| Bend | 3T |
| Hardness | About F to H |
| M.E.K. Rubs | Passed specification |

In view of the foregoing, it is evident that the present invention is one well adapted to attain all of the objects and features herein above set forth, together with other objects and features which are inherent in the apparatus disclosed herein.

As will be readily apparent to those skilled in the art, the present invention may easily be produced in other specific forms without departing from its spirit or essential characteristics. The present invention is, therefore, to be considered as merely illustrative and not restrictive, the scope of the invention being indicated by the claims rather than the foregoing description, and all changes which come the meaning and of equivalence of the claims are therefore intended to be embraced therein.

For additional background information, reference may be made to the following references:

1. L. G. Mariera and A. Barca, Conf. Proc. Radtech Europe 1989, 107 (1989)

2. R. J. Batten, R. S. Davidson and S. A. Wilkenson, Polym. Paint Col. J., 179 (4233)

3. C. J. Decker, Appl. Poym. Sci. 28,97 (1983)

4. C. Lowe, A Match Made in Heaven (9-1995)

5. C. Lowe, the Radcoil Cocktail (9-1996)

6. Meuthen B., ECCA Conf. Trans., Brussels, October 1992

7. ECCA Test Methods, T1-T20, Brussels, Belgium 1985

8. Jay Austin M. and Beland M., Polym Paint. Col. J., 181 (4280), 169, 1991

9. Nat. Coil Coaters Assoc., It All Starts with the Finish

All of these references are incorporated by reference as if reproduced in full below.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for applying a coating to coiled metal sheet, comprising:
(a) applying a photo-polymerizable composition to the metal; and
(b) curing the composition to yield a coating.

2. The method according to claim 1 wherein the coating meets or exceeds National Coil Coaters Association guidelines for physical testing of coatings.

3. The method according to claim 1 wherein the coating passes at least a 4T bend test, at least a 95% cross-hatch adhesion test, and passes a test of at least 100 MEK rubs.

4. The method according to claim 1 wherein step (b) comprises exposing the composition to light.

5. The method according to claim 1 wherein the composition of step (a) comprises a difunctional unsaturated oligomer, an unsaturated monomer, and at least one component selected from the group consisting of: monofunctional unsaturated acrylic monomers, monofunctional unsaturated monomers, and unsaturated oligomers.

6. The method according to claim 5 wherein the composition of step (a) includes a monofunctional unsaturated monomer having a molecular weight from about 150 to about 325.

7. The method according to claim 5 wherein the composition of step (a) includes a monofunctional unsaturated monomer having a molecular weight from about 100 to 300.

8. The method according to claim 5 wherein the composition of step (a) includes a monofunctional unsaturated monomer having a molecular weight from about 130 to about 420.

9. The method according to claim 5 wherein the composition of step (a) includes a monofunctional unsaturated monomer having a molecular weight from about 130 to 320.

10. The method according to claim 5 wherein the composition of step (a) includes a difunctional unsaturated oligomer having a molecular weight from about 500 to about 8000.

11. A photo-polymerizable composition, comprising:
at least one difunctional unsaturated oligomer selected from the group consisting of:
difunctional unsaturated modified oligomers having a molecular weight from about 500 to about 10,000,
difunctional unsaturated oligomers having molecular weights from about 500 to about 10,000, and
difunctional unsaturated oligomers having molecular weights from 500 to 10,000;
at least one difunctional unsaturated monomer selected from the group consisting of:
difunctional unsaturated monomers having molecular weights from about 150 to about 400, and
difunctional unsaturated monomers having molecular weights from about 175 to about 475; and
at least one component selected from the group consisting of:
monofunctional unsaturated acrylic monomers having molecular weights from about 125 to about 475,
monofunctional unsaturated monomers having molecular weights from about 150 to about 325,
monofunctional unsaturated monomers having molecular weights from about 100 to 300
monofunctional unsaturated monomers having molecular weights from about 130 to about 420.
monofunctional unsaturated monomers having molecular weights from about 130 to 320, and
unsaturated oligomers having molecular weights from about 500 to about 8000.

12. The photo-polymerizable composition of claim 11, comprising:
from about 15 percent to about 70 percent by weight of a difunctional unsaturated modified oligomer having a molecular weight from about 500 to about 10,000;
from about 20 percent to about 60 percent by weight of a monofunctional unsaturated acrylic monomer having a molecular weight from about 125 to about 475; and
from about 5 percent to about 30 percent of a difunctional unsaturated monomer having a molecular weight from about 150 to about 400.

13. The photo-polymerizable composition of claim 11, comprising:
from about 25 to about 65 weight percent of a difunctional unsaturated oligomer having a molecular weight from about 500 to about 6000;
from about 5 to about 65 weight percent of a monofunctional unsaturated monomer having a molecular weight from about 150 to about 325; and
from about 1 to about 25 weight percent of a monofunctional unsaturated monomer having a molecular weight from about 100 to 300.

14. The photo-polymerizable composition of claim 11, comprising:
from about 10 to about 60 weight percent of a difunctional unsaturated oligomer having a molecular weight from about 500 to about 10,000;
from about 12 to about 50 weight percent of an unsaturated oligomer having a molecular weight from about 500 to about 8000; and
from about 5 to about 50 weight percent of a monofunctional unsaturated monomer having a molecular weight from about 130 to about 420.

15. The photo-polymerizable composition of claim 11, comprising:
from about 20 to about 70 weight percent of a modified difunctional unsaturated oligomer having a molecular weight from about 500 to 10,000;
from about 30 to about 55 weight percent of a difunctional unsaturated monomer having a molecular weight from about 175 to about 475; and
from about 3 to about 25 weight percent of a monofunctional unsaturated monomer having a molecular weight of from 130 to 320.

16. The photo-polymerizable composition of claim 11, comprising:
from about 16 to about 65 percent by weight of a difunctional unsaturated oligomer having a molecular weight from 500 to 10,000;
from about 9 to about 40 percent by weight of a difunctional unsaturated oligomer having a molecular weight from about 500 to about 8000;
from 9 to 52 percent by weight of a difunctional unsaturated oligomer having a molecular weight from 500 to 10,000; and
from about 5 percent to about 40 percent by weight of a monofunctional unsaturated monomer having a molecular weight from about 130 to 320.

17. The photo-polymerizable composition of claim 11 wherein after polymerization on a metal surface the coating meets or exceeds National Coil Coaters Association guidelines for physical testing of coatings.

19. The photo-polymerizable composition of claim 11 wherein after polymerization on a metal surface the coating passes at least a 4T bend test, at least a 95% cross-hatch adhesion test, and passes a test of at least 100 MEK rubs.

20. The photo-polymerizable composition of claim 11, further including a photo-initiator.

21. The photo-polymerizable composition of claim 11, further including a pigment.

22. A photo-polymerizable composition that can be applied to coiled metal sheet and, when cured, adheres to the metal sheet with sufficient strength to withstand standard commercial coating tests.
